(19) United States
(12) Patent Application Publication
(10) Pub. No.: US 2004/0267381 A1
(43) Pub. Date: Dec. 30, 2004

(54) System for controlling a component

(75) Inventors: Howard Shelton Lambert, Southampton (GB); James Ronald L. Orchard, Eastleigh (GB)

Correspondence Address: IBM Corporation, IP Law Department, 11400 Burnet Road, Austin, TX, 78758, US

(73) Assignee: International Business Machines Corporation, Armonk, NY

(21) Appl. No.: 10/698,193

(22) Filed: Oct. 30, 2003

(30) Foreign Application Priority Data
Jun. 26, 2003 (GB) 0314907.7

(51) Int. Cl. G05B 11/32; G05B 11/01

(52) U.S. Cl. 700/19; 700/19; 700/20

(57) ABSTRACT

A system for controlling a first component, for example, a process, a device, a service. The system comprises means for interrogating a first parameter having an associated threshold, means for determining whether the first parameter meets the associated threshold and means, responsive to a successful determination, for adjusting a second parameter for controlling the first component. The first and second parameters are expressed as a logical expression and each parameter comprises at least three values corresponding to a minimum value and a maximum value together representing a range and a variable value.

### FIELD OF THE INVENTION

The present invention relates to a system for controlling a component.

### BACKGROUND OF THE INVENTION

Today, parameters associated with a component (e.g. device, process etc.) can be managed by an owning entity (e.g. user, application etc.). In an example of a system comprising an owning application and an associated device (e.g. a broadband modem), the application can control the modem's behaviour with respect to data rate (e.g. increasing or decreasing the data rate) by manually setting the data rate parameter. A disadvantage associated with this system is that the component needs to wait for instructions from the owning entity and this is inflexible and also causes delay.

U.S. Pat. No. 6,278,693, issued on Aug. 21, 2001 describes a communications system with associated Quality of Service (QoS) parameters. A simple language is defined for the manipulation of QoS parameters. The inter-dependence of QoS parameters is reflected in that requests comprising parameters are specified in terms of logical expressions, which for example, algebraically relate the different parameters. The logical expressions are resolved to determine whether or not the quality of service requested can be supported. Each parameter is specified as a minimum/maximum value pair corresponding to the desired range for that parameter (i.e. parameter[Min]; parameter[Max]). The use of minimum/maximum pairs provides more effective control than the use of a single target figure for example. Furthermore, conventional arithmetic operations are provided addition, subtraction, multiplication, division, plus a remainder function—along with control flow constructions (if . . . then . . . else), including normal logical tests (less than, equals, greater than, etc). Since the algebra is predominantly defined with respect to value pairs, logical tests are included for determining whether one range is exclusive or inclusive of another range.

There is a need for a more flexible system that gives an entity the ability to determine its level of involvement in management of parameters.

### SUMMARY OF THE INVENTION

According to a first aspect, the present invention provides a system for controlling a first component comprising: means for interrogating a first parameter having an associated threshold; means for determining whether the first parameter meets the associated threshold; and means, responsive to a successful determination, for adjusting a second parameter for controlling the first component, wherein the first and second parameters are expressed as a logical expression and wherein each parameter comprises at least three values corresponding to a minimum value and a maximum value together representing a range and a variable value.

Preferably, the system further comprises means for initialising each parameter, wherein upon initialisation, the variable value represents an initial value. In one embodiment, an application program executes the means for initialising. In a preferred embodiment, upon interrogation, the variable value represents a current value. Aptly, the system comprises means, responsive to the current value of the first parameter lying outside of the range, for executing an action. E.g. paging a systems administrator, sounding an alarm etc.

In a preferred embodiment, the means for adjusting adjusts the current value of the second parameter e.g. decreasing the current value, increasing the current value. In one embodiment, the system further comprises a network and a second component and the second parameter controls the first and second components.

Advantageously, the present invention provides a system for controlling a component in response to the environment, thereby optimizing performance of that component. Preferably, at least one “trigger parameter” triggers a control program when it reaches an associated threshold. The control program adjusts at least one “control parameter”, that is responsible for controlling the component. Advantageously, an entity that owns the component does not need to become involved in this process. However, preferably, if the trigger parameter's current value lies outside of the range the initialised trigger parameter, control passes back to the owning entity, so that it can take action.

Furthermore, by providing a trackable third value, the present invention provides a reactive mechanism, that takes action based on certain events. The present invention can therefore handle systems comprising variable parameters. The present invention is also flexible and can be manipulated easily, without intrusion, if the environment changes.

It should be understood that the components can be devices, programs, processes, services etc. It should be understood that the parameters represent parameters that can vary (e.g. security attributes, compression attributes, display attributes etc.).

According to a second aspect, the present invention provides a method of controlling a first component comprising the steps of: interrogating a first parameter having an associated threshold; determining whether the first parameter meets the associated threshold; and adjusting, in response to a successful determination, a second parameter for controlling the first component, wherein the first and second parameters are expressed as a logical expression and wherein each parameter comprises at least three values corresponding to a minimum value and a maximum value together representing a range and a variable value.

According to a third aspect, the present invention provides a computer program comprising program code means adapted to perform the method as described above when said program is run on a computer.

According to a fourth aspect, the present invention provides a system for controlling a first medical component comprising: means for interrogating a first physiological parameter having an associated threshold; means for determining whether the first physiological parameter meets the associated threshold; and means, responsive to a successful determination, for adjusting a second physiological parameter for controlling the first medical component, wherein the first and second physiological parameters are expressed as a logical expression and wherein each physiological parameter comprises at least three values corresponding to a minimum value and a maximum value together representing a range and a variable value.

In one embodiment, the first medical component is a device having at least one associated syringe driver. In this embodiment, preferably, the first physiological parameter represents the blood sugar level of a patient and the second physiological parameter represents either an insulin level or a sugar solution level. In another embodiment, the first physiological parameter represents heart rate and the second physiological parameter represents an amount of a drug. It should be understood that the physiological parameters could represent any other parameter (e.g. blood pressure).

### BRIEF DESCRIPTION OF THE DRAWINGS

The present invention will now be described, by way of example only, with reference to preferred embodiments thereof, as illustrated in the following drawings:

FIG. 1 shows an overview of one example of a system in which the present invention can be implemented; and

FIG. 2 shows an overview of another example of a system in which the present invention can be implemented.

### DETAILED DESCRIPTION OF THE INVENTION

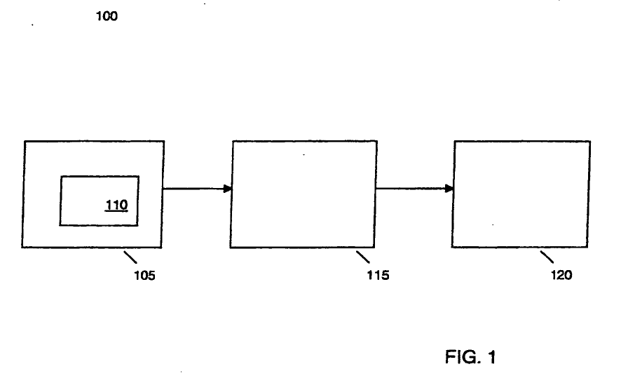

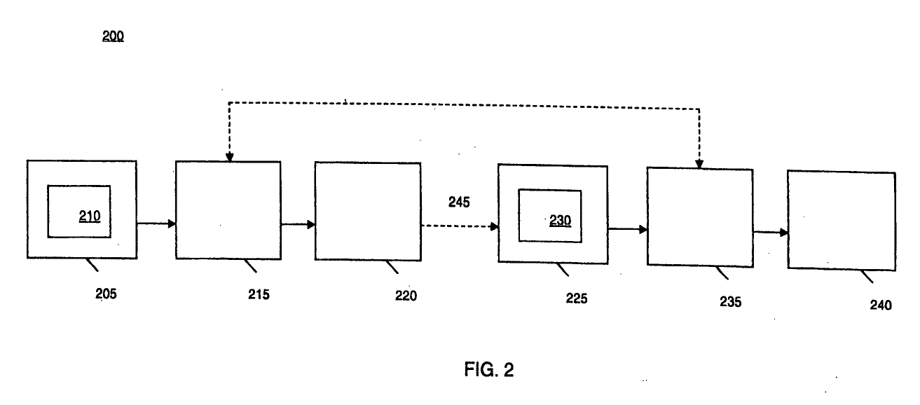

The present invention provides a system for controlling a component's (e.g. process, service, device etc.) behaviour via parameters. Each parameter is specified as a triplet of values, comprising a minimum value; a maximum value and a third value representing an initial value or a current value. The triplet and various use cases will now be described in more detail with reference to FIGS. 1 and 2. It should also be understood that the values used herein are for example purposes only.

A first use case is described with reference to a system (100) shown in FIG. 1. The system (100) comprises a blood sugar monitor (105), running an application program (110), wherein the application program (110) communicates with a medical device (120) (in this example, the device is a syringe driver comprising insulin and a syringe driver comprising a sugar solution). The system also comprises a control program (115), which is defined by the algorithmic language described in GB patent application 9608434.8 and is set up before communications begin.

In this use case, the component to be controlled is the device (120). The parameters are physiological parameters and represent the level of blood sugar in a patient (in millimoles per litre), an amount of insulin (in units per hour) and an amount of sugar solution (in units per hour).

Before communication begins, preferably, the application program (110) initializes (i.e. writes) the parameters. For each parameter, a minimum acceptable value, a maximum acceptable value and a third value is specified. At this stage, the third value (a variable value) represents an initial or ideal value.

BloodSugar[Min]:=4.0;

BloodSugar[Max]:=8.0;

BloodSugar[Use]:=5.5;

AmountInsulin[Min]:=0;

AmountInsulin[Max]:=4;

AmountInsulin[Use]:=AmountInsulin[Min];

AmountSolution[Min]:=0;

AmountSolution [Max]:=4;

AmountSolution [Use]:=AmountSolution[Min]

The control program (115) is also set up and is constructed to automatically control the device (120):

```
Begin
  If BloodSugar[Use] > 6.0 Then
      AmountInsulin[Use] :=1
    Else
  If BloodSugar[Use] < 4.5 Then
      AmountSolution[Use] := 1;
  Wait (60, Mins);
End;
```

Now, when control is passed to the control program (115), the third values of the parameters represent the current (i.e. actual) values. Throughout execution, this value may vary, and the control program (115) interrogates (i.e. reads) the current values. In this example, the current value for blood sugar is 7.0 and as neither insulin nor sugar solution have been administered to the patient, the current value for these parameters is 0.

Although the current value for blood sugar lies within the specified range, it does not match the initial value. Furthermore, the current value for blood sugar triggers the first condition (i.e. a blood sugar level of more than 6) in the control program (115). Therefore, in response to the current value for blood sugar, the control program (115) executes a write operation to adjust (i.e. re-set) the third value of the insulin parameter to “AmountInsulin[Use]:=1”. This results in administration of one unit of insulin from the syringe driver. This action controls the device's (120) behaviour in light of the higher actual blood sugar level. Referring to the control program (115), the third values are again interrogated after an hour.

In this example, when the third values are interrogated again, the current value for blood sugar is 4.3, for insulin is 0 and for the sugar solution is 0. Therefore, although the current values lie within the specified range, the current value for blood sugar does not match the initial value. Furthermore, the current value for blood sugar triggers the second condition (i.e. a blood sugar level of less than 4.5) in the control program (115). Therefore, in response to the current value for blood sugar, the control program (115) executes a write operation to adjust (i.e. re-set) the third value of the sugar solution parameter to “AmountSolution[Use]:=1”. This results in administration of one unit of sugar solution from the syringe driver. This action controls the device's (120) behaviour in light of the lower actual blood sugar level. Referring to the control program (115), the third values are again interrogated after an hour.

In this example, the current value for blood sugar is 5.8, for insulin is 0 and for the sugar solution is 0. Although the current value for blood sugar does not match the initial value, nothing is done, because neither of the trigger conditions of the control program (115) have been met. Referring to the control program (115), the third values are again interrogated after an hour.

In this example, the current value for blood sugar is 3.9, for insulin is 0 and for the sugar solution is 0 and therefore, the current value for blood sugar lies outside the specified range for that parameter. Preferably, control is passed back to the application program (110). At this stage, the application program (110) preferably executes an action e.g. raising an event such as an alarm.

The blood sugar parameter is a “trigger parameter”, since it triggers the control program (115) when it reaches either of its associated thresholds. The insulin and solution parameters control the device (120). Therefore it can be seen that the control program automatically controls a component when a trigger parameter's current value lies within the bounds of the initialised parameter. Advantageously, the owning application (or user, service etc.) does not become involved in the process. However, preferably, control passes back to the owning application (or user, service etc.) when the current value lies outside of the specified bounds.

A second use case is described with reference to a system (100) shown in FIG. 1. The system (100) comprises a client computer (105), running an application program (110). The application program (110) communicates with a device (120) (in this example, the device is a broadband modem). The system also comprises a control program (115).

In this use case, the component to be controlled is the broadband modem (120). The parameters involved represent error rate (in units per second) and data rate (in kilobits). Before communication begins, preferably, the application program (110) initializes (i.e. writes) the parameters. For each parameter, a minimum and maximum acceptable value and an initial or ideal value are specified:

Rate[Min]:=64;

Rate[Max]:=2000;

Rate[Use]:=256;

Error[Min]:=0;

Error[Max]:=10;

Error[Use]:=4.5;

The control program (115) is also set up and is constructed to automatically control the broadband modem (120):

```
If Error[Use] > 5 Then
  Begin
    Rate[Use] := Rate[Use] / 2;
    If Rate[Use] < Rate[Min] Then
        Rate[Use] := Rate[Min];
    End;
  Else
If Error[Use] < 1 Then
  Begin
      Rate[Use] := Rate[Use] * 2;
      If Rate[Use] > Rate[Max] Then
        Rate[Use] := Rate[Max];
  End;
```

Now, when control is passed to the control program (115), the third values of the parameters represent the current (i.e. actual) values. Throughout communications, the control program (115) interrogates (i.e. reads) the current values. In this example, the current value for data rate is 128 and the current value for error rate is 8.

Although the current values lie within the specified range, the current values do not match the initial values. Furthermore, the current value for error rate triggers the first condition (i.e. error rate of more than 5) in the control program (115). Therefore, in response to the current value for error rate, the control program (115) executes a write operation to adjust (i.e. re-set) the third value of the date rate parameter to “Rate[Use]:=Rate[Use]/2”, which resets the value of the data rate of the broadband modem (120) to 64. This action controls the broadband modem's (120) behaviour in light of the higher actual value for error rate, as typically, decreasing the data rate will decrease the error rate as well.

When the third values are interrogated again, the current value for data rate is 64 and the current value for error rate is 0.7. Therefore, although the current values lie within the specified range, the current values do not match the initial values. Furthermore, in order to optimise performance in the system, the second condition (i.e. an error rate of less than 1) in the control program (115) is triggered. Therefore, in response to the current value for error rate, the control program (115) executes a write operation to adjust (i.e. re-set) the third value of the data rate parameter to “Rate[Use]:=Rate[Use]*2”. The value of the data rate of the broadband modem (120) is therefore reset to 128 and this allows more data to be received per second, which is acceptable when the error rate is lower.

When the third values are interrogated again, the current value for data rate is 256 and for error rate is 11. In this case, the current value for error rate lies outside the specified range for that parameter. Preferably, control is passed back to the application program (110), which executes an action e.g. paging a systems administrator.

A third use case is described with reference to a system (200) shown in FIG. 2. The system (200) comprises a client computer (205), running an application program “1” (210). The application program “1” (210) communicates with a device (in this example, the device is a camera (220)). The system (200) also comprises an intermediate control program “1” (215). The client computer (205) communicates over a network (245) via a broadband modem with a server computer (225), running an application program “2” (230). The application program “2” (230) communicates with a device (in this example, the device is a monitor (240)). The system (200) also comprises an intermediate control program “2” (235). In this example, the control programs (215, 235) communicate with each other in order to ensure that they are behaving in a complementary manner. In the system (200), the camera (220) captures frames at a frame rate, which are sent over the network (245) and rendered by the monitor (240) at that frame rate. Generally, the capabilities of the camera (220) and monitor (240) should correspond and it should be understood that typically, the capabilities vary over a range.

In this use case, the components to be controlled are the camera (220) and the monitor (240). The parameters involved represent frame rate (in frames per second) and data rate (in kilobits). Before communication begins, preferably, the application program (210) initializes (i.e. writes) the parameters. For each parameter, a minimum and maximum acceptable value and an initial or ideal value are specified:

Rate[Min]:=64;

Rate[Max]:=2000;

Rate[Use]:=256;

FrameRate[Min]:=15;

FrameRate[Max]:=25;

FrameRate[Use]:=FrameRate[Max].

The control programs (215, 235) are also set up and are constructed to automatically control the camera (220) and monitor (240):

```
If Rate[Use] > 100 Then
  Begin
    FrameRate[Use] := FrameRate [Max];
  Else
If Rate[Use] < 80 Then
    FrameRate[Use] := 20;
  End;
```

Now, when control is passed to the control programs (215, 235), the third values of the parameters represent the current (i.e. actual) values. Throughout communications, the control programs (215, 235) interrogate (i.e. reads) the current values. In this example, the current value for data rate is 128 and the current value for frame rate is 25 and since the first condition (i.e. data rate of more than 100) in the control programs (215, 235) is already being met and fulfilled, nothing is done.

When the third values are interrogated again, the current value for data rate is 70 and the current value for frame rate is 25. Therefore, although the current values lie within the specified range, and the current value for frame rate matches the initial value, the second condition (i.e. a data rate of less than 80) in the control programs (215, 235) is triggered. Therefore, in response to the current value for date rate, the control programs (215, 235) execute a write operation to adjust (i.e. re-set) the third value of the frame rate parameter to “FrameRate[Use]:=20”. This action controls the camera's and monitor's behaviour in light of the lower actual data rate of the system (200) and therefore optimizes performance.

When the third values are interrogated again, the current value for data rate is 50 and the current value for frame rate is 20. In this case, the current value for date rate lies outside the specified range for that parameter. Preferably, control is passed back to application program “1” (210), which executes an action. In a first example, the camera (220) is stopped and a microphone is set to capture audio only. In a second example, another control program “3” (not shown) that is constructed to deal with data rates falling within the range 20-64, is executed.

Advantageously, the present invention allows dynamic control of a component such that its behavior optimised. Furthermore, a component can be controlled without interrupting owning applications, user, services etc., unless the current value of the trigger parameter falls outside of the specified range.

It should be understood that the present invention is applicable to any type of parameter. For example, an entity might specify a desired percentage of CPU time (or perhaps MIP or MFLOP rate), memory requirements (in kbytes, MBytes or whatever), biological values (e.g. blood pressure, heart rate) etc.

The present invention is preferably embodied as a computer program product for use with a computer system. Such an implementation may comprise a series of computer readable instructions either fixed on a tangible medium, such as a computer readable media, e.g., diskette, CD-ROM, ROM, or hard disk, or transmittable to a computer system, via a modem or other interface device, over either a tangible medium, including but not limited to optical or analog communications lines, or intangibly using wireless techniques, including but not limited to microwave, infrared or other transmission techniques. The series of computer readable instructions embodies all or part of the functionality previously described herein.

Those skilled in the art will appreciate that such computer readable instructions can be written in a number of programming languages for use with many computer architectures or operating systems. Further, such instructions may be stored using any memory technology, present or future, including but not limited to, semiconductor, magnetic, or optical, or transmitted using any communications technology, present or future, including but not limited to optical, infrared, or microwave. It is contemplated that such a computer program product may be distributed as a removable media with accompanying printed or electronic documentation, e.g., shrink wrapped software, pre-loaded with a computer system, e.g., on a system ROM or fixed disk, or distributed from a server or electronic bulletin board over a network, e.g., the Internet or World Wide Web.

1. A system for controlling a first component comprising:
means for interrogating a first parameter having an associated threshold;
means for determining whether the first parameter meets the associated threshold; and
means, responsive to a successful determination, for adjusting a second parameter for controlling the first component,
wherein the first and second parameters are expressed as a logical expression and wherein each parameter comprises at least three values corresponding to a minimum value and a maximum value together representing a range and a variable value.

2. A system as claimed in claim 1, further comprising means for initialising each parameter, wherein upon initialisation, the variable value represents an initial value.

3. A system as claimed in claim 1, wherein upon interrogation, the variable value represents a current value.

4. A system as claimed in claim 3, comprising means, responsive to the current value of the first parameter lying outside of the range, for executing an action.

5. A system as claimed in claim 3, wherein the means for adjusting adjusts the current value of the second parameter.

6. A system as claimed in claim 2, wherein the means for initialising is executed by an application program.

7. A system as claimed in claim 1, further comprising a network and a second component, wherein the second parameter controls the first and second components.

8. A method of controlling a first component comprising the steps of:
interrogating a first parameter having an associated threshold;
determining whether the first parameter meets the associated threshold; and
adjusting, in response to a successful determination, a second parameter for controlling the first component,
wherein the first and second parameters are expressed as a logical expression and wherein each parameter comprises at least three values corresponding to a minimum value and a maximum value together representing a range and a variable value.

9. A method as claimed in claim 8, further comprising the step of initialising each parameter, wherein upon initialisation, the variable value represents an initial value.

10. A method as claimed in claim 8, wherein upon interrogation, the variable value represents a current value.

11. A method as claimed in claim 1Q, further comprising the step of executing, in response to the current value of the first parameter lying outside of the range, an action.

12. A method as claimed in claim 10, wherein in the adjusting step, the current value of the second parameter is adjusted.

13. A method as claimed in claim 9, wherein an application program executes the initialising step.

14. A method as claimed in claim 8, for use in a system comprising a network and a second component, wherein the second parameter controls the first and second components.

15. A computer program comprising program code means adapted to perform the method of claim 8 when said program is run on a computer.

16. A system for controlling a first medical component comprising:
means for interrogating a first physiological parameter having an associated threshold;
means for determining whether the first physiological parameter meets the associated threshold; and
means, responsive to a successful determination, for adjusting a second physiological parameter for controlling the first medical component,
wherein the first and second physiological parameters are expressed as a logical expression and wherein each physiological parameter comprises at least three values corresponding to a minimum value and a maximum value together representing a range and a variable value.

17. A system as claimed in claim 16, further comprising means for initialising each physiological parameter, wherein upon initialisation, the variable value represents an initial value.

18. A system as claimed in claim 16, wherein upon interrogation, the variable value represents a current value.

19. A system as claimed in claim 18, comprising means, responsive to the current value of the first physiological parameter lying outside of the range, for executing an action.

20. A system as claimed in claim 18, wherein the means for adjusting adjusts the current value of the second physiological parameter.

21. A system as claimed in claim 17, wherein the means for initialising is executed by an application program.

22. A system as claimed in claim 16, further comprising a network and a second medical component, wherein the second physiological parameter controls the first and second medical components.

23. A system as claimed in claim 16, wherein the first medical component is at least one syringe driver.

24. A system as claimed in claim 23, wherein the first physiological parameter represents a blood sugar level.

25. A system as claimed in claim 24, wherein the second physiological parameter represents an insulin level.

26. A system as claimed in claim 24, wherein the second physiological parameter represents a sugar solution level.

27. A system as claimed in claim 16, wherein the first physiological parameter represents heart rate.

28. A system as claimed in claim 27, wherein the second physiological parameter represents an amount of a drug.
